(19) United States
(12) Patent Application Publication
(10) Pub. No.: US 2006/0174502 A1
(43) Pub. Date: Aug. 10, 2006

(54) Linear and angular measuring apparatus

(76) Inventor: Stephen Crane, Boulder, CO (US)

Correspondence Address: LATHROP & GAGE LC, 4845 PEARL EAST CIRCLE, SUITE 300, BOULDER, CO, 80301, US

(21) Appl. No.: 11/053,796

(22) Filed: Feb. 9, 2005

(51) Int. Cl. B43L 7/08

(52) U.S. Cl. 33/437

(57) ABSTRACT

Linear measuring apparatus includes: a guide member extending along a work platform; a drive carriage for movement along the guide member; and a read head, coupled to the drive carriage, for generating a digital number representative of distance corresponding to the movement. Angular measuring apparatus includes: a structural member having an encoder PCB extending in an arc about an axis of rotation through the structural member; a rotor arm for rotating about the axis of rotation, the rotor arm having a contact element that contacts the encoder PCB during the rotation; and a microprocessor electronically coupled with the encoder PCB and configured to determine an angle based upon the rotation.

### BACKGROUND

Tools used in woodworking include the measuring tape, right angle bracket and the table saw. Skilled craftsmen utilize these tools and others to make wooden products, for example. Often, precision and measurement accuracy for these products is lessened due to human error in utilizing the tools, for example due to human interpretation of angle or distance. U.S. Pat. No. 5,142,793 discloses a digital linear measuring device and is incorporated herein by reference.

### SUMMARY

In one embodiment, linear measuring apparatus includes: a guide member extending along a work platform; a drive carriage for movement along the guide member; and a read head, coupled to the drive carriage, for generating a digital number representative of distance corresponding to the movement.

In another embodiment, linear measuring apparatus includes: a guide rail extending along a work platform, the guide rail comprising a bar code; a drive carriage for movement along the guide rail; and a read head, coupled to the drive carriage and having a bar code reader and an incremental encoder, for generating a digital number from (a) the bar code reader reading the bar code and (b) rotation of the encoder, the digital number representative of distance corresponding to the movement.

In one embodiment, angular measuring apparatus includes: a structural member having an encoder extending in an arc about an axis of rotation through the structural member; a rotor arm for rotating about the axis of rotation, the rotor arm having a contact element that contacts the encoder during the rotation; and a microprocessor electronically coupled with the encoder and configured to determine an angle based upon the rotation.

In one embodiment, a method determines distance or angle, by: reading, from a drive carriage, a bar code disposed on a guide rail adjacent to a work platform during movement of the drive carriage along the guide rail; utilizing an encoder to determine incremental distance or angle corresponding to the movement; and processing data from the bar code reader and the encoder to determine distance or angle of the movement.

### BRIEF DESCRIPTION OF THE FIGURES

FIG. 1 shows a table saw including one linear measuring apparatus.

FIG. 2 shows an embodiment of the fence assembly of FIG. 1.

FIG. 3 shows further exemplary detail of the fence assembly of FIG. 2.

FIG. 4 shows further exemplary detail of the fence assembly of FIG. 2.

FIG. 5 shows the drive carriage of FIG. 1 in an underside perspective view.

FIG. 6 shows the drive carriage and guide member in a cutaway view.

FIG. 7 shows an exploded view of a read head in accord with an embodiment.

FIG. 8 shows an operational view of a drive carriage, including the encoder of FIG. 7.

FIG. 9 shows a schematic view of the linear measuring apparatus of FIG. 1.

FIG. 9A shows a schematic, cross-sectional view of the linear measuring apparatus of FIG. 9.

FIG. 10 shows a schematic view of the drive carriage, and without connection to the fence or guide member.

FIG. 11 shows further detail of encoders of read head 10, in an embodiment.

FIG. 12 shows an end view of the read head, along with illustrative positioning of bar code within guide member.

FIG. 13 shows an angular measuring apparatus.

FIG. 14 shows exemplary features of the angular measuring apparatus of FIG. 13.

FIG. 15 shows an embodiment of the printed circuit board and encoders of the angular measuring apparatus of FIG. 13.

### DETAILED DESCRIPTION OF THE FIGURES

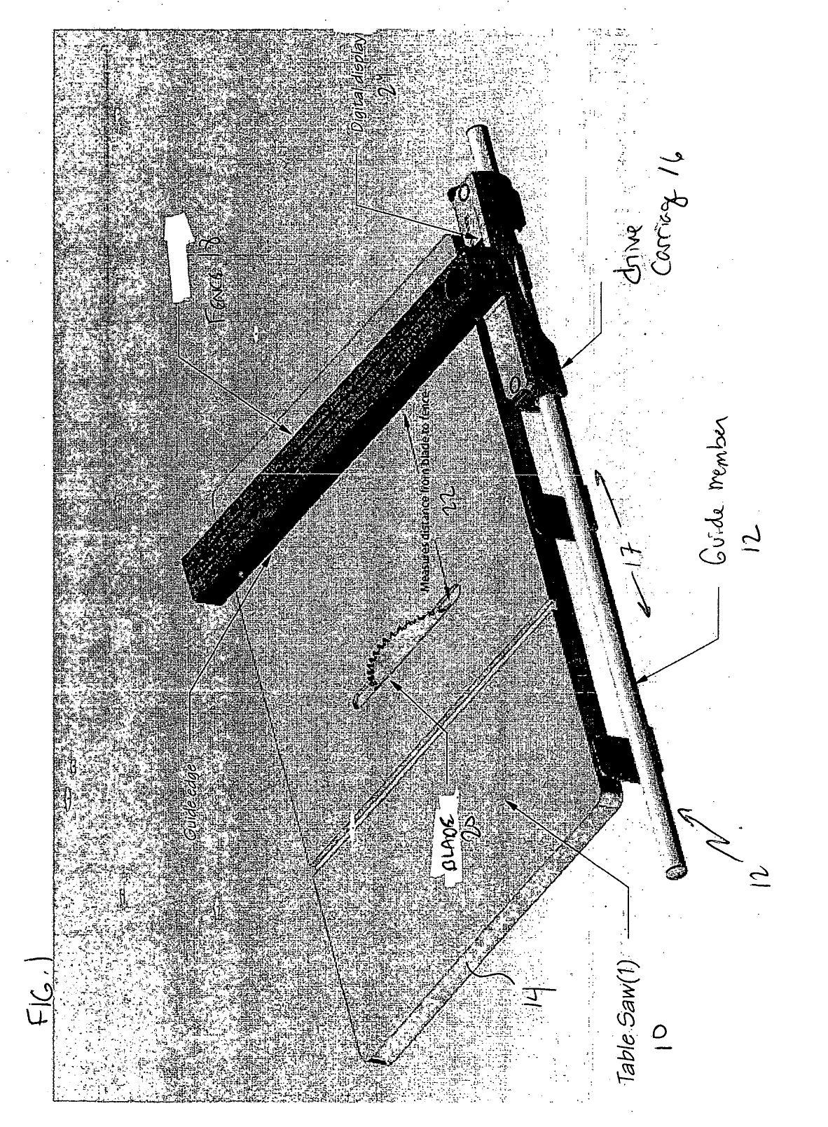

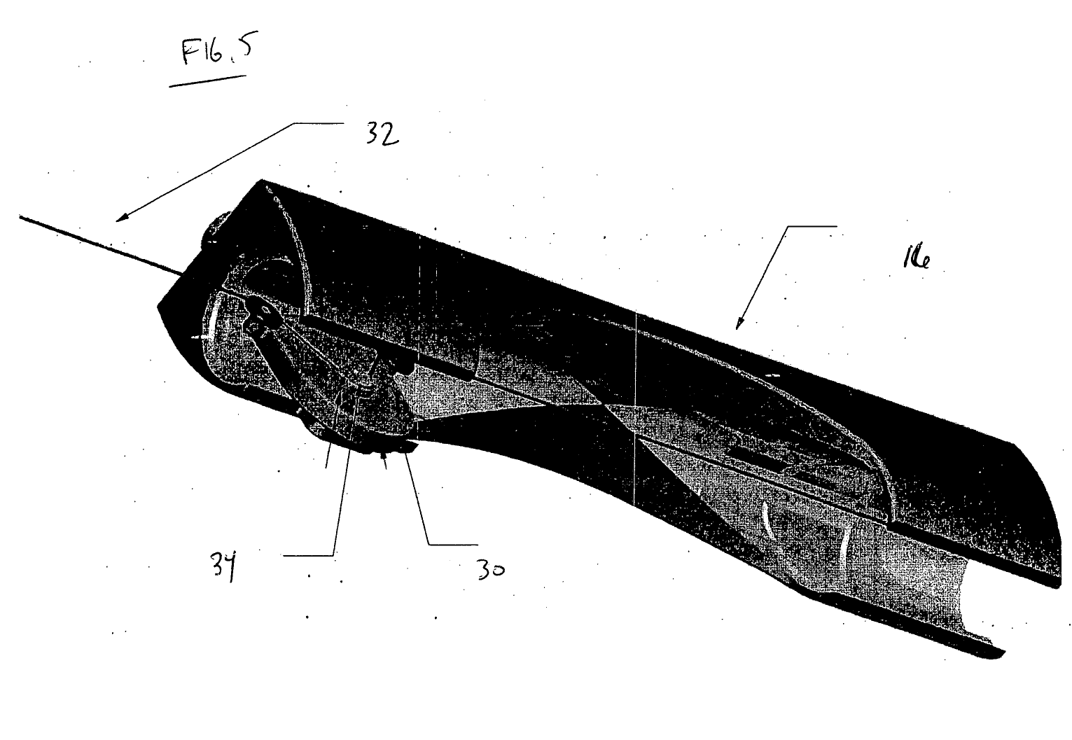

FIG. 1 shows an embodiment of a table saw 10 with linear measuring apparatus. The linear measuring apparatus includes a guide member 12 extending along a work platform 14. A drive carriage 16 is arranged for movement (shown as arrow 17) along guide member 12. As described in more detail below, a read head (see FIG. 5-FIG. 9) couples to drive carriage 16, and generates a digital number representative of distance corresponding to movement 17 along guide member 12.

Table saw 10 is for example suitable for use in woodworking or construction, to cut or alter a piece of wood or other material. The linear measuring apparatus may include a fence 18 that is used to guide wood as it is being cut by a blade 20 of table saw 10. Fence 18 may for example couple to drive carriage 16, as shown, and extend perpendicularly from axis of movement 17; it may be aligned to blade 10 at a user selected distance 22 from blade 20, and then locked in position as the wood or other material is guided along the guide edge of fence 18. Once fence 18 is set, the wood or material is cut to size equaling distance 22. Distance 22 is for example displayed in a digital display 24 of drive carriage 16, such that a user may view display 24 and simultaneously set distance 22 to a desired size.

As described in more detail below, in one embodiment, the linear measuring apparatus is removable from table saw 10, so that it may be incorporated or attached to other machines requiring similar linear measurement, such as like band saws, planers, etc.

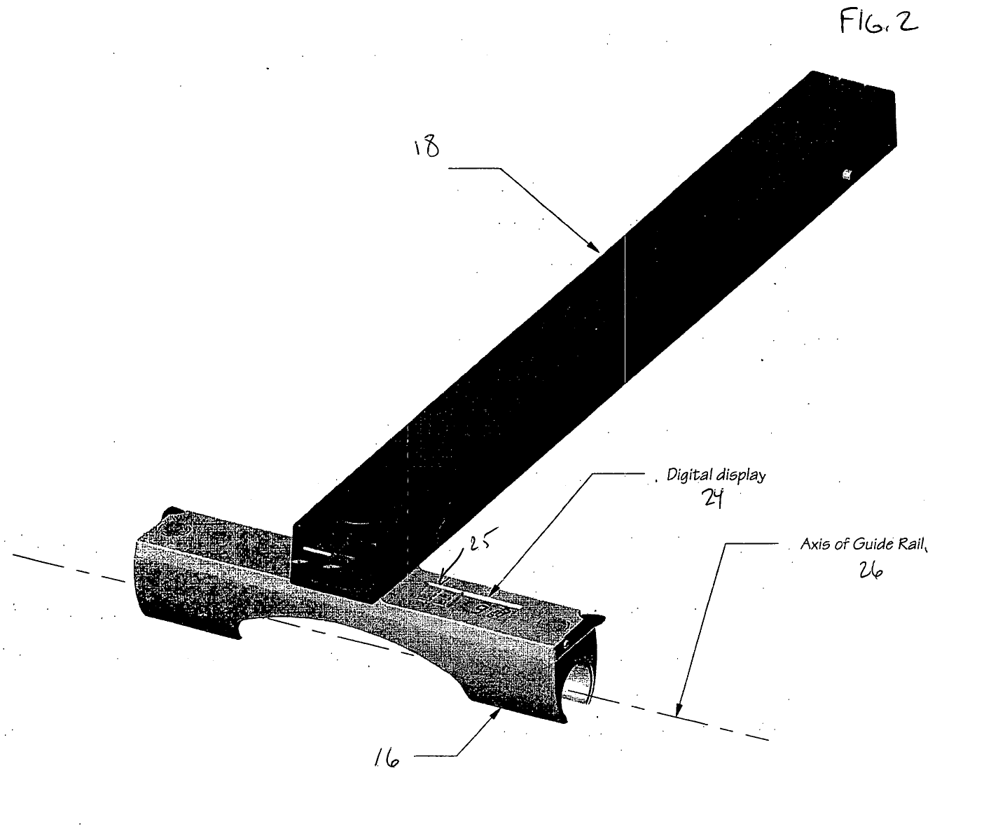

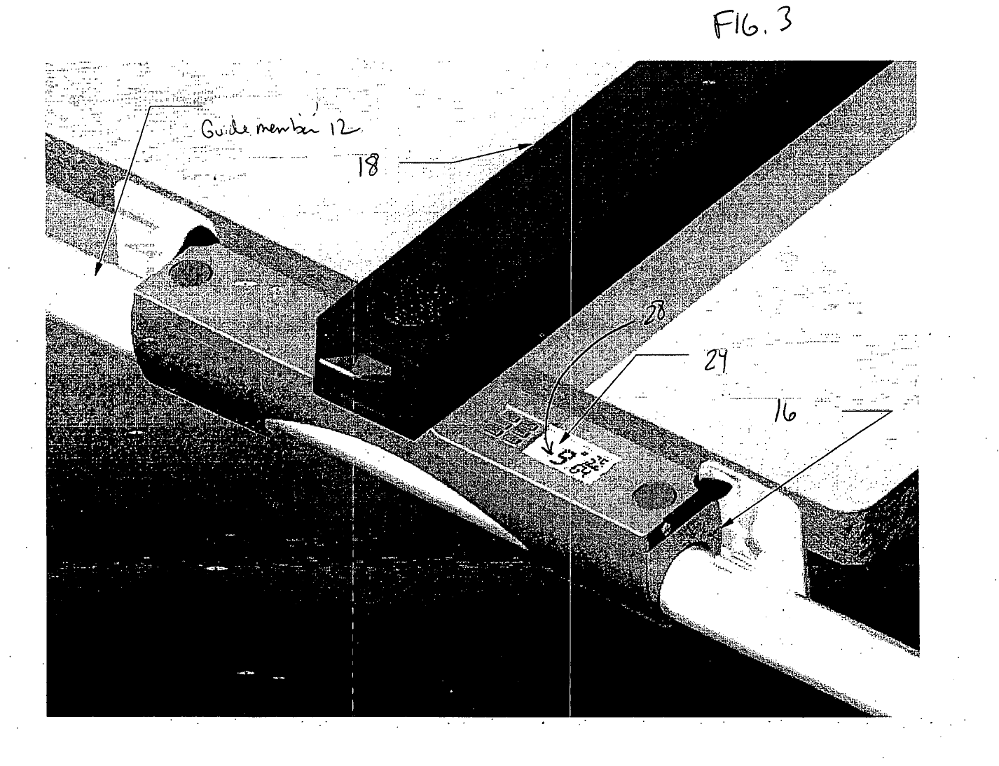

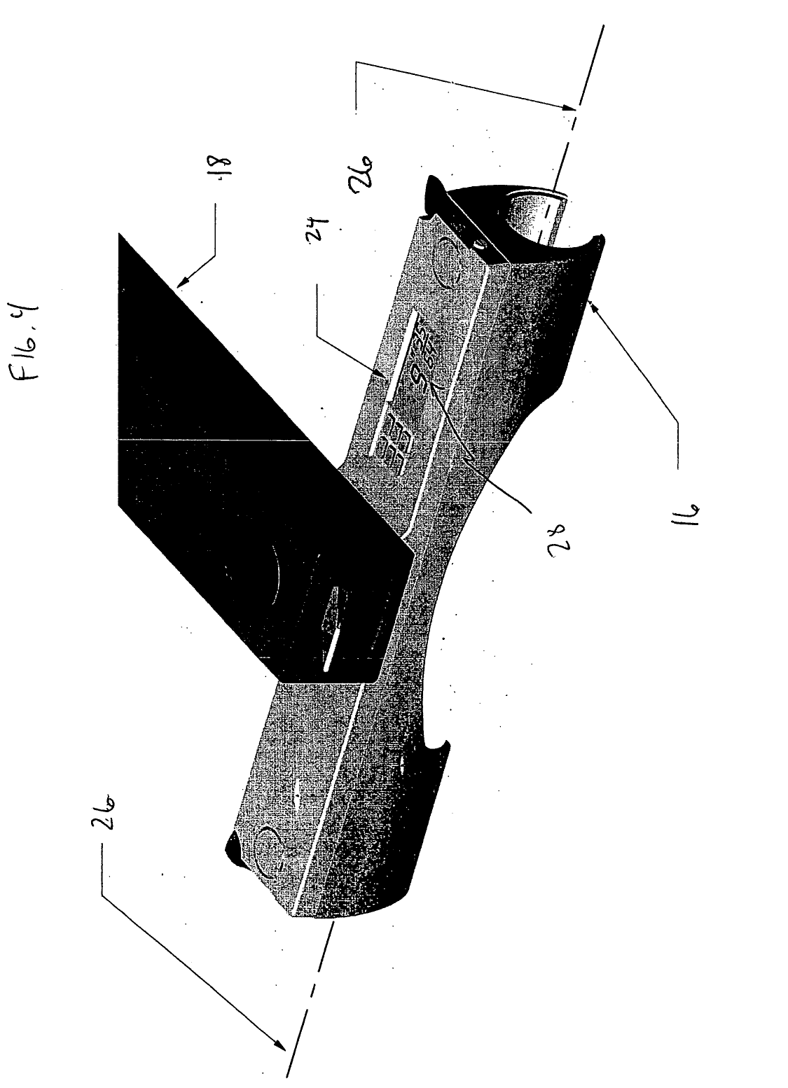

Drive carriage 16 and fence 18 thus form a fence assembly shown in more detail in FIG. 2. FIG. 2 further illustrates an axis 26 of guide member 12; axis 26 for example corresponds to movement 17, FIG. 1. FIG. 3 further illustrates the fence assembly, as well as exemplary numerals 28 shown by digital display 24. In FIG. 4, the fence assembly further illustrates that digital display 24 may display numerals 28 with fractional numbers, which may facilitate carpentry for example.

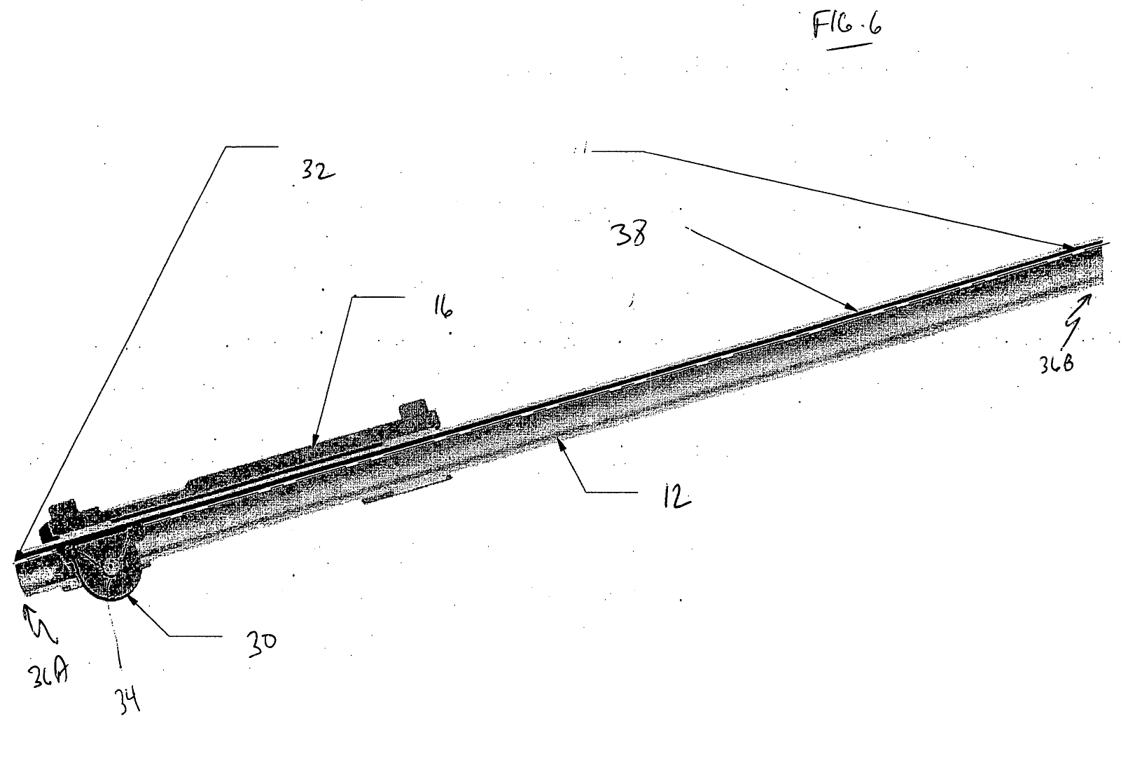

FIG. 5 shows, in an embodiment, an underside of the fence assembly. Inside drive carriage 16 is a read head 30, as shown. A drive cable 32 is also shown in FIG. 5. Drive cable 32 for example extends along and within guide member 12, and is used by read head to accurately measure movement 17. Accordingly, guide member 12 may be tubular and form a slot for read head 30, as shown. See also FIG. 6. A drive sheave 34 of read head 30 contacts drive cable 32 and rotates when drive carriage 16 moves along axis 17 (i.e., since drive cable is fixed within guide member 12, drive sheave 34 rotates during this movement).

In FIG. 6, guide member 12 and drive carriage 16 are shown in a cutaway view. FIG. 6 further illustrates that cable 32 is fixed, in this embodiment, to both ends 36A, 36B of guide member 12. A bar code 38 is disposed within guide member 12. Read head 30 reads bar code 38 during movement along axis 26, and as further described below.

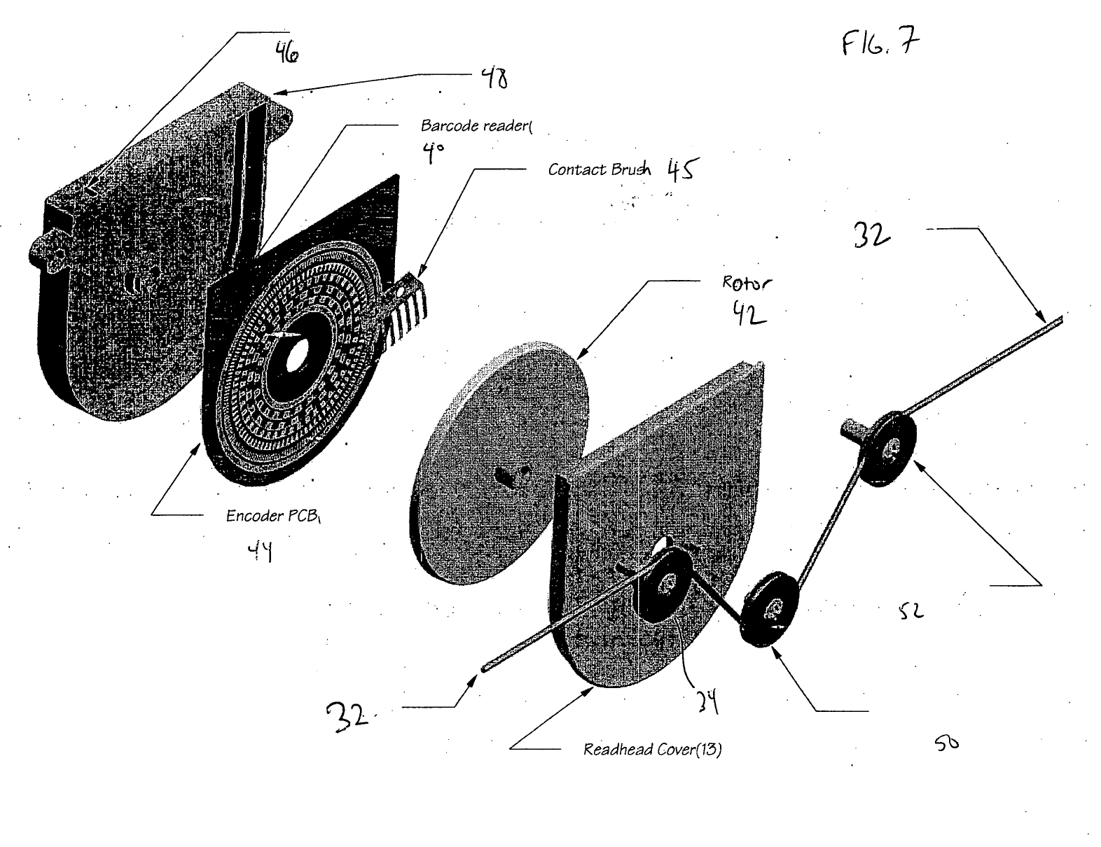

FIG. 7 shows an exploded view of read head 10 in accord with an embodiment. Read head 10 reads bar code 38 printed or etched on the inside of guide member 12. More particularly, bar code 38 is positioned above a bar code reader 40 of read head 30 and, when read, serves to provide absolute position of drive carriage 16 along guide member 12. Read head 10 may thus be considered an “absolute encoder” when reading bar code 38. It is also an “incremental” encoder, since drive sheave 34 (and related mechanics of read head 30) may be used to determine each displacement along axis 26. Read head 10 thus includes a rotor 42 and an incremental encoder 44; a printed circuit board (PCB) within encoder 44 processes data from both incremental and absolute encoders to produce a digital number (e.g., numerals 28, FIG. 4).

It should be clear that read head 30 may be formed with different components to provide like function. For example, rotation of the rotor 42 can be sensed with mechanical wipers, a contact brush 45 attached to rotor 42 (as shown), or it can include capacitive, magnetic, optical, electric, or elements which may be used in detection of rotation. Similarly, bar code 38 may therefore be optical, capacitive or magnetic so long as bar code reader 40 is compatible. One exemplary implementation includes mechanical wipers on a Gray code rotary encoder (for incremental encoder 44), and barcode 38 with an optical reader 40 for the absolute encoder.

Bar code reader 40 views bar code 38 through an opening 46 in a housing 48 of read head 30. Housing 48 attaches to drive carriage 16 so that both incremental and absolute encoders are inside guide member 12, to protect the encoders from sawdust or chips or particles from cut material. A drive sheave 50 and cable tensioner 52 may be used with cable 32 to minimize slippage and to provide a speed-increasing gearing effect on rotor 42. This supports fine resolution measurements without requiring very fine angular measurement (as would be required without the gearing effect). These cable tensioners 50, 52 are moveable and loaded toward the rotor hub (about drive sheave 34) to maintain tension in cable 32. Nonetheless, slippage in cable 32 has only a minor effect on the accuracy of the linear measuring apparatus because it may automatically recalibrate at the end of every barcode.

FIG. 7 also shows a cover which may couple to housing 48, to seal components therein.

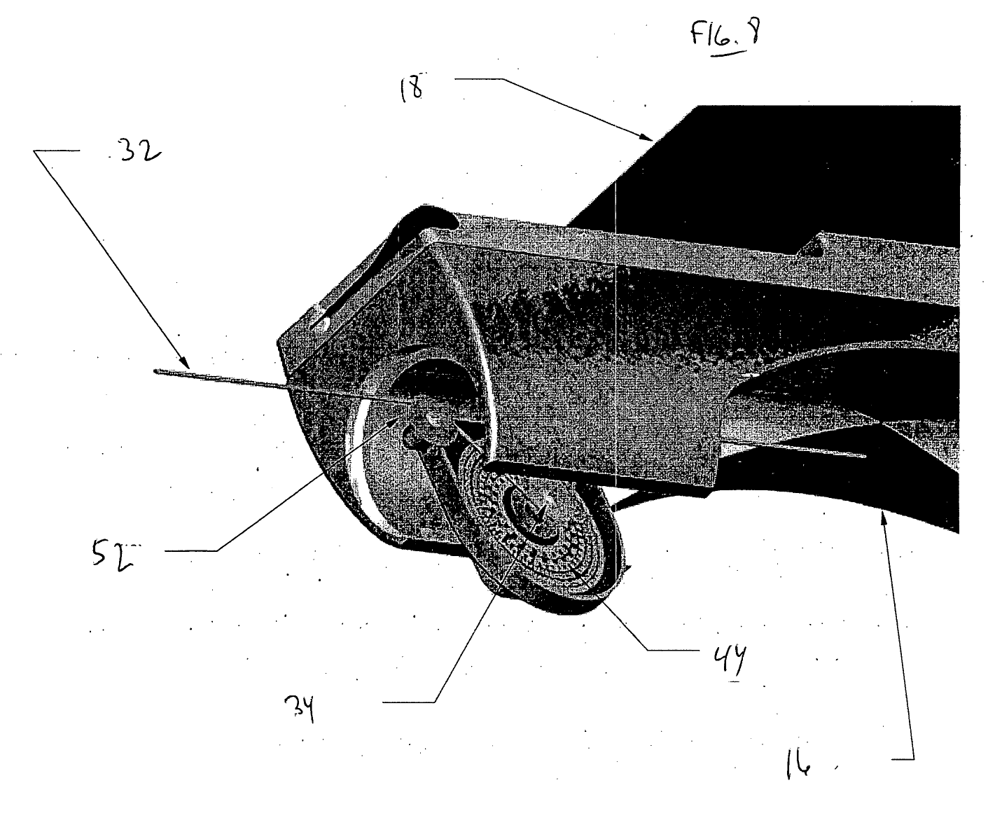

FIG. 8 shows an operational view of a drive carriage, including the encoder 44 (the cover of read head 10 is removed to show encoder 44).

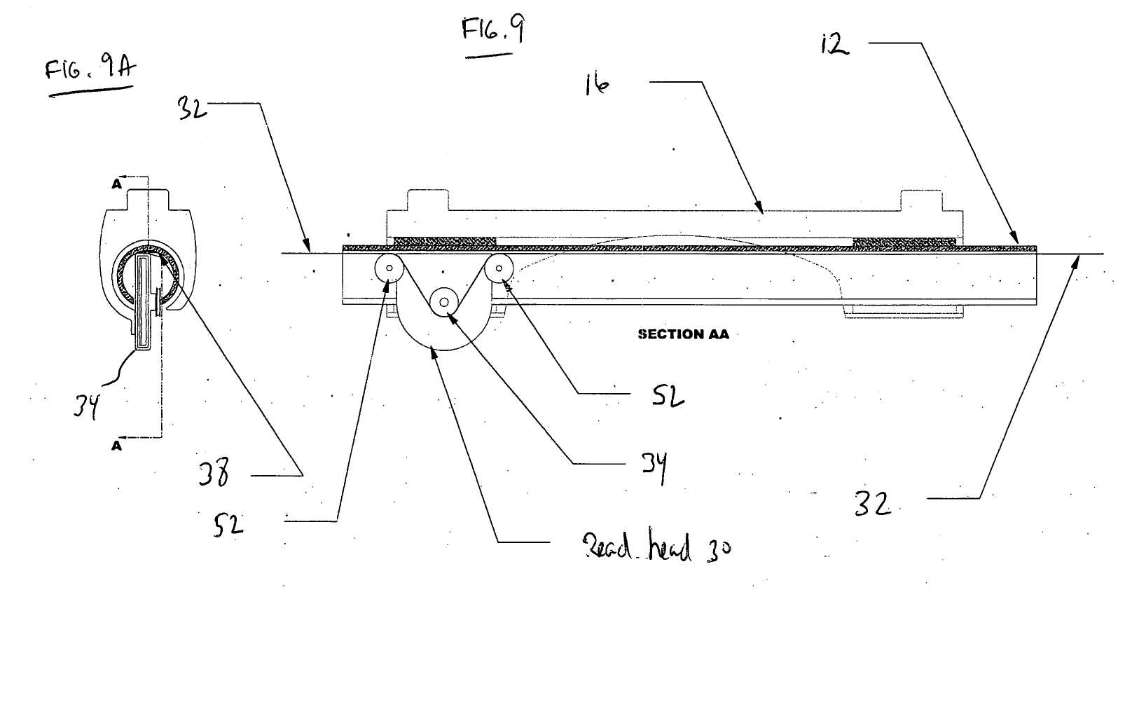

FIG. 9 shows a schematic drawing of the linear measuring apparatus discussed above. FIG. 9A shows a schematic, cross-sectional view of the linear measuring apparatus of FIG. 9. FIG. 9A also illustrates position of bar code 38.

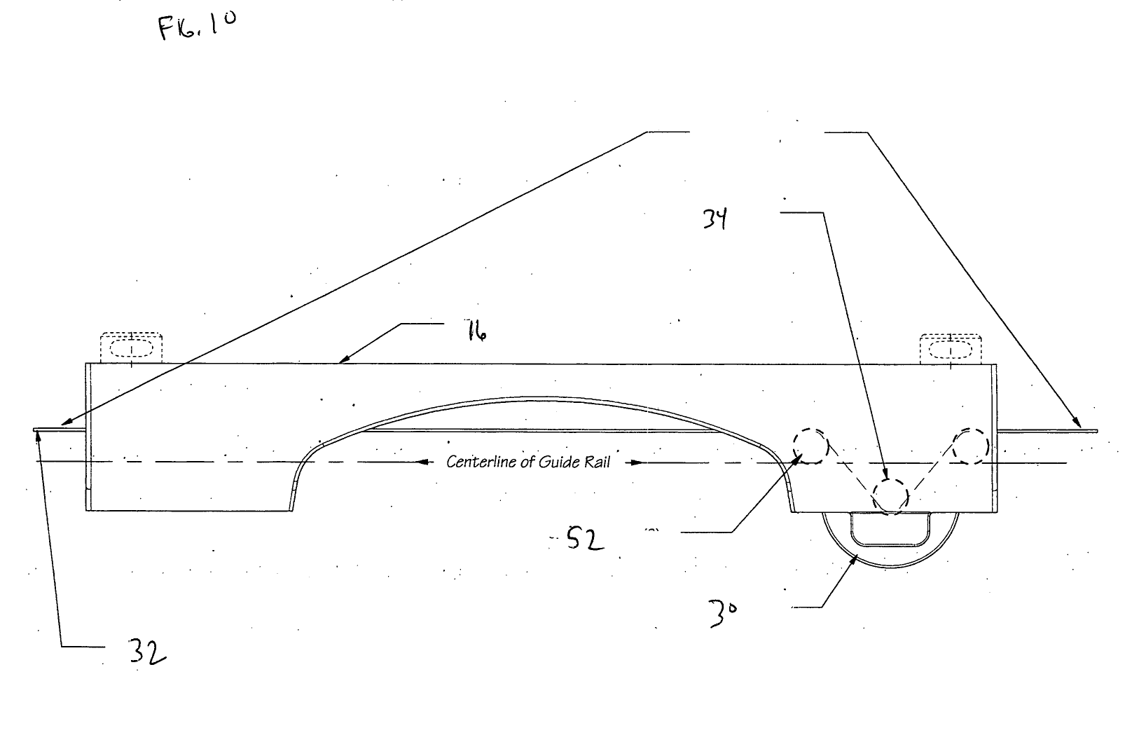

FIG. 10 shows a schematic view of drive carriage 16, and without connection to the fence or guide member.

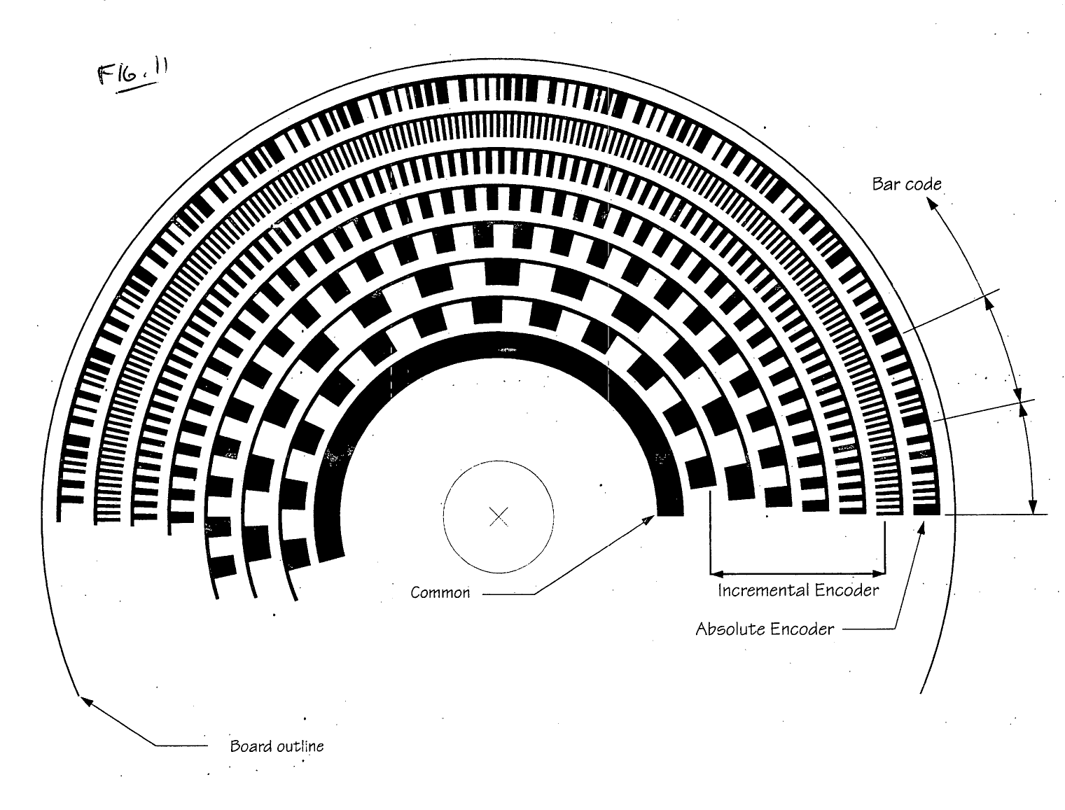

FIG. 11 shows further detail of encoders of read head 10, in an embodiment.

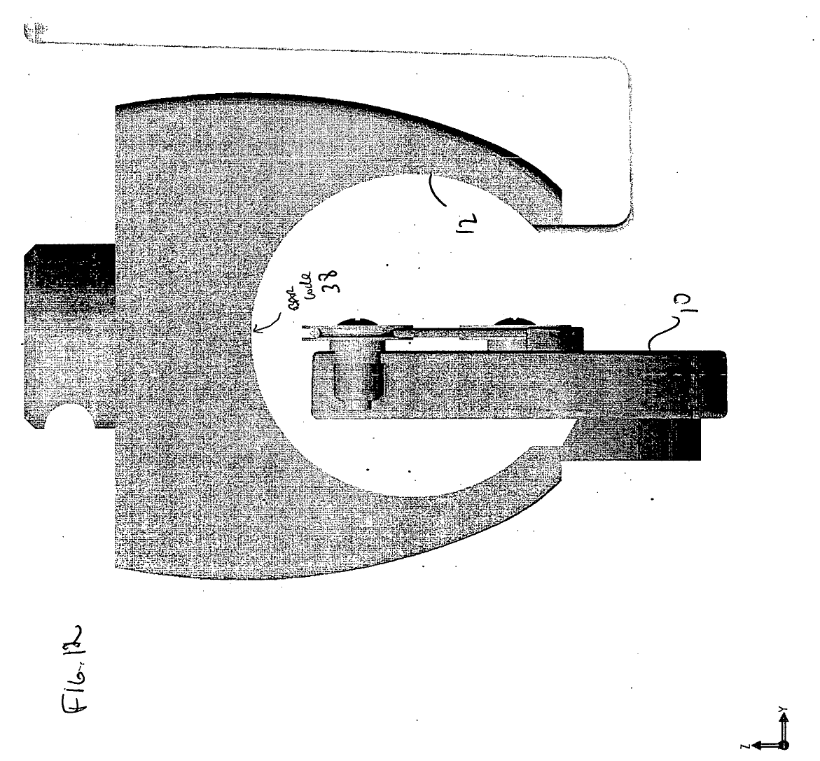

FIG. 12 shows an end view of read head 10, along with positioning of bar code 38 within guide member 12.

Accordingly, table saw 10 of FIG. 1 illustrates one application of the linear measuring apparatus. In this application, drive carriage 16 moves along the axis of the tubular guide member 12 and fence 18, running parallel to blade 20, provides a guide for cutting wood to a controlled measurement (determined by distance 22). By referring to digital display 24 on drive carriage 16, and by locking fence 18 in position, wood can be cut to the desired measurement. The zero point of the readout can be set referenced to appropriate points such as the side of the blade for cut-to-length applications, or the center of the blade for centerline-to-centerline slotting. Fence 18 can be removed from table saw 10 and reattached without disturbing the set point of the readout. The use of two encoders, one absolute and one relative (incremental), provides certain measurement advantages.

In one embodiment, encoder 44 contains a microprocessor which processes motion of the drive carriage 16; this permits the incorporation of additional features added to embedded software of the microprocessor. Such features may be selected and controlled by an operator interface, such as the small keypad 25 shown next to display 24 in FIG. 2. The features can include alternate measurement systems (inches or metric), fixed offsets in the cutting point, multiple partial cuts (grooves) such as making several grooves 5¾ inches apart, etc. A communications capability (serial port or network connection) can be included to connect the drive carriage to other equipment.

As noted earlier, the linear measuring apparatus described above is readily adaptable to other similar machines, such as automatic cutoff saws, panel saws (big saws for cutting large sheets like plywood), sheet metal cutters, glass cutters; ceramic tile cutters, etc.

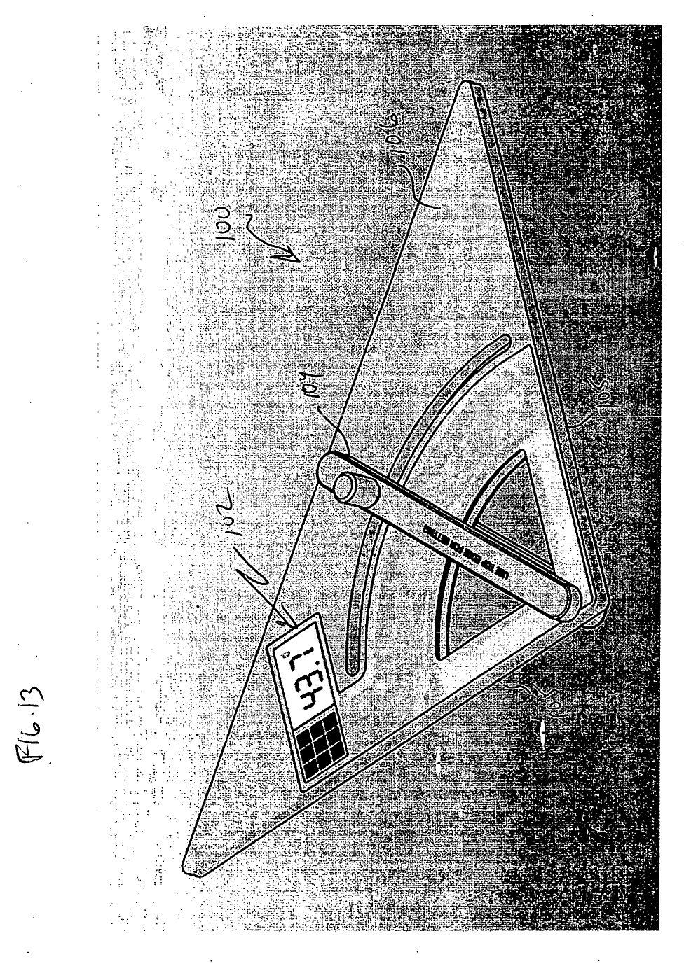

FIG. 13 shows an angular measuring apparatus 100. Apparatus 100 includes a digital display 102 which displays angular measurements formed by rotation of rotor arm 104. Apparatus 100 is for example suitable for use in woodworking or other applications where rotor arm 104 is set at a desired angle relative to an edge 105 of a base bracket 106.

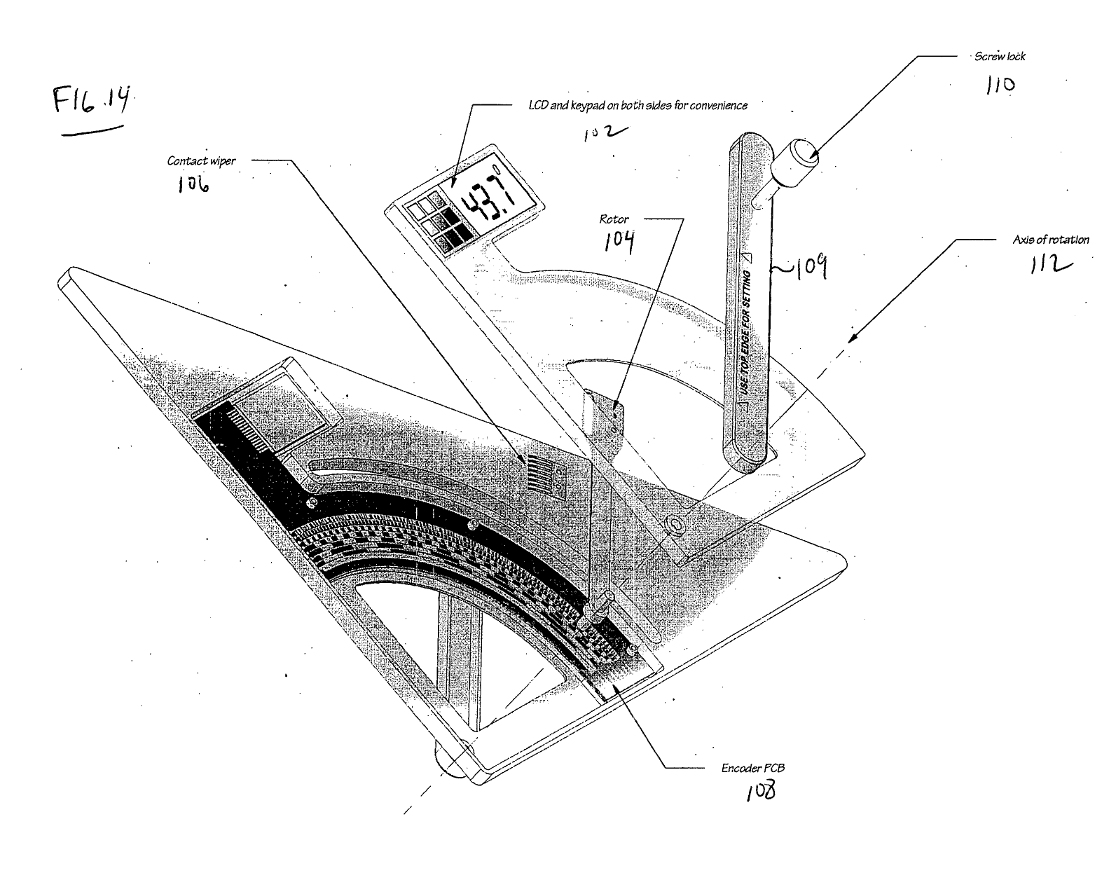

FIG. 14 shows exemplary features and assembly of angular measuring apparatus 10 of FIG. 13. In FIG. 14, display 102 is an liquid crystal display with a keypad, similar to display 24, FIG. 1. A contact wiper 106 couples to rotor arm 104 to interface with an encoder 108 (which, again, includes a PCB therein to process data for apparatus 10). Rotor arm 104 may be locked in place via a screw lock assembly 109 (which couples to rotor arm 1054) and a screw lock 110, as shown, to fix rotor arm 104 to a desired angle about an axis of rotation 112.

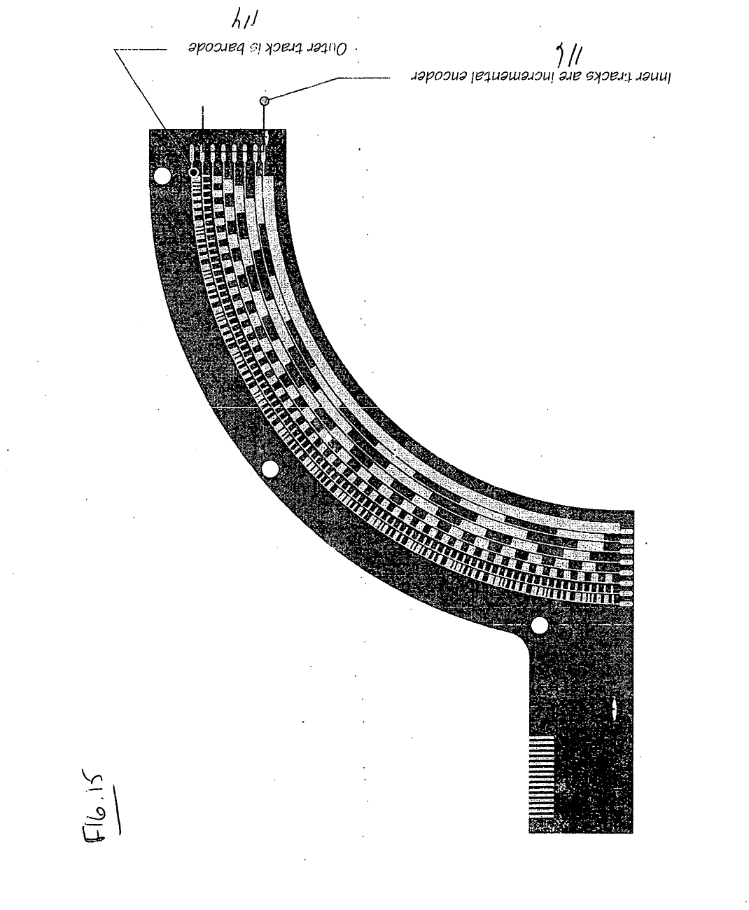

FIG. 15 shows an embodiment of encoder 108 and encoders of the angular measuring apparatus of FIG. 13. Similar to operation of the linear measuring apparatus, FIG. 1, apparatus 100 provides absolute and incremental encoding, through bar code 114 and inner tracks 116 of encoder 108. Rotation of rotor arm 104 thus engages contact wiper 106 with encoder 108, which in turn processes incremental and absolute positions of rotor arm 104 to produce angle for display 102.

Changes may be made in the above methods and systems without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall there between.

What is claimed is:

1. Linear measuring apparatus, comprising:
a guide member extending along a work platform;
a drive carriage for movement along the guide member; and
a read head, coupled to the drive carriage, for generating a digital number representative of distance corresponding to the movement.

2. Linear measuring apparatus of claim 1, the guide member comprising a guide rail for supporting the drive carriage.

3. Linear measuring apparatus of claim 2, the guide member comprising a bar code.

4. Linear measuring apparatus of claim 3, the read head comprising a bar code reader that views the bar code, and further comprising a microprocessor for determining the digital number based upon readings of the bar code associated with the movement.

5. Linear measuring apparatus of claim 4, the bar code reader comprising one of an optical reader, a capacitive reader and a magnetic reader.

6. Linear measuring apparatus of claim 4, further comprising a digital display, coupled with the carriage, for displaying the digital number.

7. Linear measuring apparatus of claims 4, the guide member comprising a drive cable, and the read head comprising a drive sheeve that contacts the drive cable and rotates during the movement.

8. Linear measuring apparatus of claim 7, the read head comprising a rotor connected for rotation with the drive sheeve.

9. Linear measuring apparatus of claim 8, further comprising a contact brush coupled with the rotor, the read head comprising an encoder PCB having the microprocessor, wherein the encoder PCB determines incremental distance of the movement by contact between the contact brush and the encoder PCB.

10. Linear measuring apparatus of claim 9, the encoder PCB comprising a gray code rotary encoder.

11. Linear measuring apparatus of claim 9, further comprising a digital display for displaying the digital number.

12. Linear measuring apparatus of claim 11, the drive carriage comprising a user interface for selecting characteristics of the digital number.

13. Linear measuring apparatus of claim 12, the characteristics comprising one or more of units of metric and inches, an offset, a zero point, and multiple groove distances.

14. Linear measuring apparatus of claim 9, the read head comprising a housing forming an aperture for the bar code reader to view the bar code.

15. Linear measuring apparatus of claim 4, further comprising at least one cable tensioner for tensioning the drive cable.

16. Linear measuring apparatus of claim 1, further comprising a communications port coupled with the read head, for communicating digital information from the read head to electronics external to the read head.

17. Linear measuring apparatus of claim 1, the guide member being tubular.

18. Linear measuring apparatus of claim 1, further comprising a fence, coupled to the drive carriage and extending perpendicularly from an axis of movement.

19. Linear measuring apparatus of claim 1, the work platform forming one of a table for a table saw, a table for an automatic cutoff saw, a table for a panel saw, a table for sheet metal cutters, a table for glass cutters, and a table for tile cutters.

20. Linear measuring apparatus, comprising:
a guide rail extending along a work platform, the guide rail comprising a bar code;
a drive carriage for movement along the guide rail; and
a read head, coupled to the drive carriage and having a bar code reader and an incremental encoder PCB, for generating a digital number from (a) the bar code reader reading the bar code and (b) rotation of the encoder PCB, the digital number representative of distance corresponding to the movement.

21. Linear measuring apparatus of claim 20, further comprising a digital display, coupled with the carriage, for displaying the digital number.

22. Linear measuring apparatus of claims 20, the guide member comprising a drive cable, and the read head comprising a drive sheeve, that contacts the drive cable and rotates during the movement, and a rotor, connected for rotation with the drive sheeve.

23. Linear measuring apparatus of claim 22, further comprising a contact brush coupled with the rotor, wherein the encoder PCB determines incremental distance of the movement by contact between the contact brush and the encoder PCB.

24. Linear measuring apparatus of claim 20, the read head comprising a housing forming an aperture for the bar code reader to view the bar code.

25. Linear measuring apparatus of claim 20, further comprising a fence, coupled to the drive carriage and extending perpendicularly from an axis of movement.

26. Angular measuring apparatus, comprising:
a structural member having an encoder PCB extending in an arc about an axis of rotation through the structural member;
a rotor arm for rotating about the axis of rotation, the rotor arm having a contact element that contacts the encoder PCB during the rotation; and
a microprocessor electronically coupled with the encoder PCB and configured to determine an angle based upon the rotation.

27. Angular measuring apparatus of claim 26, further comprising a digital display for displaying the angle.

28. Angular measuring apparatus of claim 26, further comprising a bar code extending along the arc, and wherein the rotor arm comprises a bar code reader to read the bar code, the microprocessor utilizing the reading of the bar code reader to determine an absolute angle of travel during the rotation.

29. A method for determining distance or angle, comprising:
from a drive carriage, reading a bar code disposed on a guide rail adjacent to a work platform during movement of the drive carriage along the guide rail;
utilizing an encoder PCB to determine incremental distance or angle corresponding to the movement; and
processing data from the bar code reader and the encoder PCB to determine distance or angle of the movement.

30. The method of claim 29, the step of utilizing comprising rotating a contact brush across the encoder PCB.
